(19) United States
(12) Patent Application Publication
(10) Pub. No.: US 2013/0088020 A1
(43) Pub. Date: Apr. 11, 2013

(54) Method, System, Apparatus to generate electricity from objects under motion

(71) Applicant: Lalitha Vellore Sripathi Rao, Santa Clara, CA (US)

(72) Inventor: Lalitha Vellore Sripathi Rao, Santa Clara, CA (US)

(21) Appl. No.: 13/197,776

(22) Filed: Oct. 11, 2011

(51) Int. Cl. F03G 7/08

(52) U.S. Cl. 290/1 R

(57) ABSTRACT

The current invention is a method or system or apparatus to generate energy from objects under motion that make contact with a solid surface. This method uses a combination of electromagnetic and piezoelectric mechanisms for generating electricity. In this method, motion or vibration of object is converted to electricity. This method can be used either in singularity or plurality in parking lots, railway systems, road transportation, cargo industry, staircases, shopping malls, airports, ship decks, gyms, etc. where there is constant motion or vibration over a solid surface.

### BACKGROUND OF INVENTION

In our daily lives we see lot of places where vibration or motion is generated by various mechanisms—such as, vibration generated during walking, vibration generated during a gym workout, vibration generated by moving vehicles, etc. Such energy generated by motion or vibration has not effectively been utilized thus far. This invention addresses generating electricity by harnessing energy produced during motion or vibration and using the generated electricity in our daily lives. The electricity generated can be used locally by facility or can be transported across the electric grid.

### DETAILED DESCRIPTION OF INVENTION

This invention is a multimodal energy harnessing method or system or apparatus that combines electromagnetic and piezoelectric energy harvesting mechanisms to both individually and mutually generate electric output. Piezoelectric materials individually generate electricity when subjected to stress, but, when coupled with an electromagnetic configuration/setup, the stress gets propagated further and can be harnessed to generate electricity. Spring/coil used in the electromagnetic configuration/setup acts as a mechanical energy storage device. The feedback of the vibrations that happen between the electromagnetic and piezoelectric systems when the spring/coil undergoes extension or compression leads to the efficient generation of electricity

The book “Energy harvesting technologies” by Shashank Priya and Daniel .J. Inman describes efficient methods of energy harvesting in a multimodal environment.

As depicted in FIG. 1, energy generated from vibration of an object moving on a solid surface is converted to electricity using an electromagnetic and piezoelectric framework. The electrical circuit interfacing with this framework can be designed to be a combination of, but not limited to, one or more of resistors, inductors, capacitors, semiconductors, etc for maximum efficiency.

FIG. 2 shows the framework in greater detail. Electromagnetic and piezoelectric mechanisms contribute both individually and mutually to generate electric output when mechanical stress is applied.

The electromagnetic effect is created in the framework using electromagnetic induction principles. Electromagnetic induction was discovered in 1831 by Michael Faraday. FIG. 3 depicts electromagnetic induction. Michael Faraday stated that the electromotive force (EMF) produced around a closed path is proportional to the rate of change of the magnetic flux through any surface bounded by that path. In practice, this means that an electric current will be induced in any closed circuit when the magnetic flux through a surface bounded by the conductor changes. This applies whether the field itself changes in strength or the conductor is moved through it.

In mathematical form, Faraday's law states that:

$$ɛ = - \frac{d {ϕ}_{b}}{d t}$$

### Where

∈ is the electromotive force
Φ_{b} is the magnetic flux.

For the special case of a coil of wire, composed of N loops with the same area, the equation becomes

$$ɛ = - N \frac{d {ϕ}_{b}}{d t}$$

The direction of induced current is always such that it produces a magnetic field that opposes, to a greater or lesser extent, the change in flux, depending on resistance in the circuit. Thus, if ΦB increases, the induced current produces an opposing flux. If ΦB decreases, the induced current produces an aiding flux. This is Lenz's law.

FIG. 4 denotes the phenomenon of magnetic coupling where in magnetic flux from a primary coil, carrying current, cuts a secondary coil thereby generating electricity in secondary coil. With magnetic coupling, in an ideal scenario,

$$\begin{matrix}\frac{Voltage in secondary coil}{Voltage in primary coil} = \frac{Number of turns in secondary}{Number of turns in primary} \\ = \frac{Power in secondary}{Power in primary} \\ = \frac{Current in secondary}{Current in primary}\end{matrix}$$

Piezoelectric effect was discovered by the Curie brothers in 1880. A piezoelectric substance is one that produces an electric charge when a mechanical stress is applied (the substance is squeezed or stretched). Conversely, a mechanical deformation (the substance shrinks or expands) is produced when an electric field is applied.

As depicted in FIG. 5, a piezoelectric stack could operate either in d31 or d33 modes with force applied in parallel or perpendicular to poling axis.

$${p}_{max} = \frac{{my}^{2} {w}_{n}^{3}}{4 γ}$$

pₘₐₓ=maximum power
m=mass producing vibration
y=amplitude of excitation
wₙ=resonant frequency
γ=damping

The framework has a spring or coil interspersed between piezoelectric slabs or sheets. A permanent magnet is placed at the base of the piezoelectric slab and length of the bar magnet is less than the distance between consecutive piezoelectric plates.

When mechanical stress is exerted on the top piezoelectric plate, it vibrates and produces electricity. The spring or coil serves two purposes here. First is to store and give back energy provided by the slab upon impact, with spring, during vibration. Second is to generate induced EMF when magnet attached to the base vibrates vertically with its flux cutting the coil. Change of flux with time causes electricity in the coil. The piezoelectric setup may be multilayered with interspersed electromagnetic setup.

This setup is enhanced by magnetic coupling to tap the magnetic flux generated by primary coil when current flows through it. Due to the effect of mutual induction, secondary coil placed near the primary coil carries current when its flux linkages change with time. Number of turns in second coil affects the voltage output and can be designed based on each scenario. Magnetic flux generated as part of back EMF also enhances magnetic coupling between the two coils.

Thus the framework has multiple points where electricity can be harnessed from vibration viz., piezoelectric effect, electromagnetic induction and magnetic coupling.

### Piezoelectric Constants:

d₃₃ Induced polarization in direction 3 (parallel to direction in which ceramic element is polarized) per unit stress applied in direction 3
   OR
   Induced strain in direction 3 per unit electric field applied in direction 3
d₃₁ Induced polarization in direction 3 per unit stress applied in direction 1 (perpendicular to direction in which ceramic element is polarized)
   OR
   Induced strain in direction 1 per unit of electric field applied in direction 3
g₃₃ Induced electric field in direction 3 (parallel to the direction in which ceramic element is polarized) per unit stress applied in direction 3
   OR
   Induced strain in direction 3 per unit electric displacement applied in direction 3
g₃₁ Induced electric field in direction 3 (parallel to the direction in which ceramic element is polarized) per unit stress applied in direction 1 (perpendicular to direction in which ceramic element is polarized)
   OR
   Induced strain in direction 1 per unit electric displacement applied in direction 3
∈₁₁^{T} Permittivity for dielectric displacement and electric field in direction 1 (perpendicular to the direction in which ceramic element is polarized) under constant stress
∈₃₃^{S} Permittivity for dielectric displacement and electric field in direction 3 (parallel to the direction in which ceramic element is polarized) under constant strain
S₁₁^{E} Elastic compliance for stress in direction 1 (perpendicular to the direction in which ceramic element is polarized) and accompanying strain in direction 1, under constant electric field (short circuit)
S₃₃^{O} Elastic compliance for stress in direction 3 (parallel to the direction in which ceramic element is polarized) and accompanying strain in direction 3, under constant electric displacement (open circuit)
K₃₃ Electromechanical coupling factor for electric field in direction 3 (parallel to the direction in which ceramic element is polarized) and longitudinal vibrations in direction 3
K₃₁ Electromechanical coupling factor for electric field in direction 3 (parallel to the direction in which ceramic element is polarized) and longitudinal vibrations in direction 1 (perpendicular to the direction in which ceramic element is polarized)

Dielectric constant K^{T}=∈^{T}/∈₀.
∈^{T} is permittivity of ceramic material
∈₀ is permittivity of free space 8.85*10 pow(−12) farad/meter

At high frequencies,

K_{eff}²=(fₙ_{²}−fₘ_{²})/fₙ_{²}
fₙ Max impedance (anti resonant) frequency
fₘ Min impedance (resonant) frequency

d₃₁=K₃₁∫S₁₁^{E}∈₃₃^{T}

d₃₃=K₃₃∫S₃₃^{E}∈₃₃^{T}

g₃₁=d₃₁/∈₃₃^{T}

g₃₃=d₃₃/∈₃₃^{T}

### Electromagnetic Constants:

| | |
|---|---|
| Fₑₘ = Dₑₘ dx/dt | Fₑₘ = electromagnetic force |
| | Dₑₘ = electromagnetic damping |
| | dx/dt = velocity |
| ${D}_{em} = \frac{1}{{R}_{L} + {R}_{C} + j ω {L}_{C}} {( d ϕ / dx )}^{2}$ | (dφ/dx) = flux linkage gradient R_{L} = resistance of load R_{C} = resistance of coil L_{C} = inductance of coil |
| Pₑₘ = Fₑₘdx/dt | Pₑₘ = instantaneous power due to |
| | electromagnetic force |
| B = μₘH | B = magnetic field strength |
| | μₘ = permeability of material |
| | H = magnetic field or flux density |
| φ_{ab} = M_{ab}Iₐ | φ_{ab} = magnetic flux linkage from |
| | coil ‘a’ to ‘b’ |
| | Iₐ = current in coil ‘a’ |
| | M_{ab} = mutual inductance between |
| | coil ‘a’ and ‘b’ |
| M = K(LₐL_{b})^{1/2} | K = coefficient of coupling between |
| | 2 coils |

### SUMMARY OF THE INVENTION

The energy harvester uses a combination of electromagnetic induction and piezoelectric effect to harness energy from vibration or motion. Electricity can be generated at multiple levels in the electromagnetic piezoelectric framework: the piezoelectric effect, electromagnetic induction and the magnetic coupling. This electricity obtained at different levels can be used at a local facility or can be transported over an electric grid. The electricity can be used in either serial or parallel combination depending on its application.

### DESCRIPTION OF DRAWINGS

Drawings are not to scale and they are for illustrative purpose only, meant to educate knowledgeable experts on how the various components of this invention can be put together.

FIG. 1: Depicts block diagram of energy harvesting setup in real life

FIG. 2: Depicts the electromagnetic piezoelectric framework used to harness energy from vibration or motion

FIG. 3: Describes about Faraday's law of induced EMF in a coil

FIG. 4: Describes about mutual induction and magnetic coupling between coils

FIG. 5: Depicts d33 and d31 modes of vibration in piezoelectric material

FIG. 6: Depicts various points of energy tapping in energy harvester setup

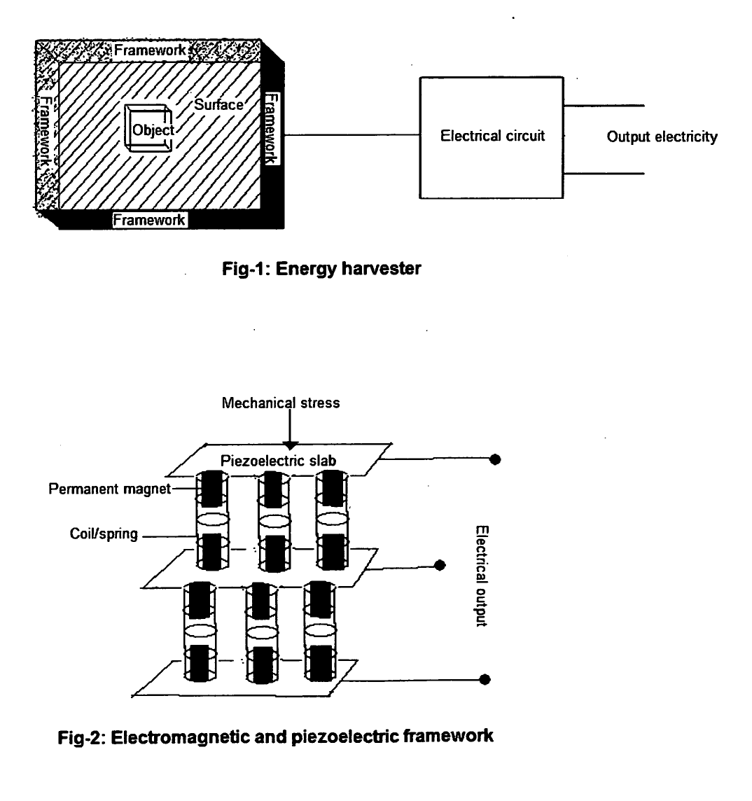

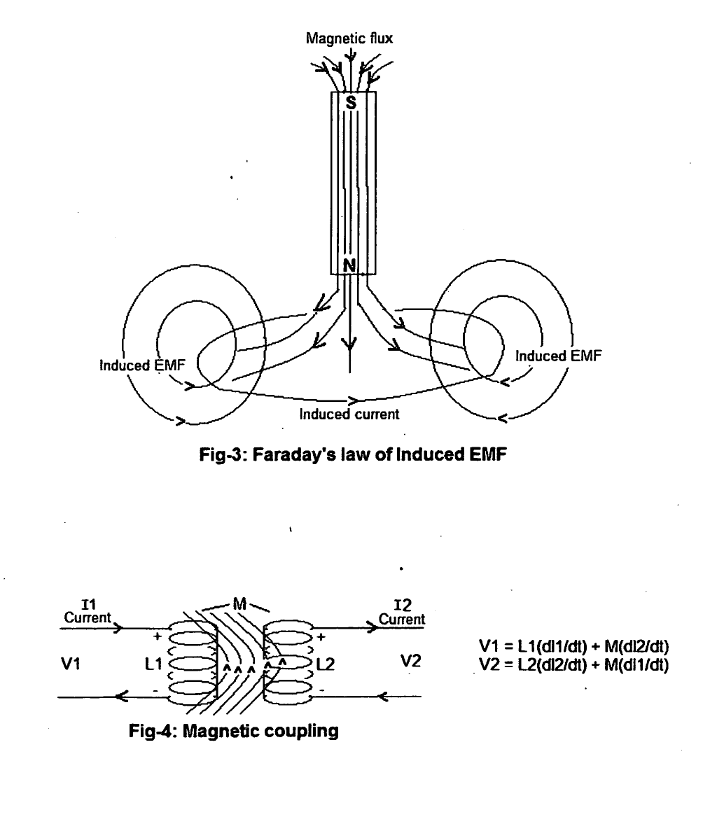

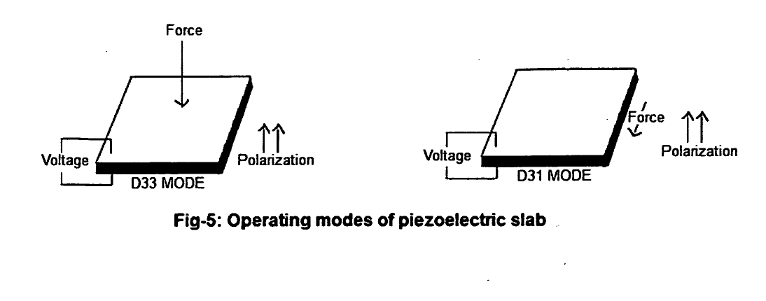

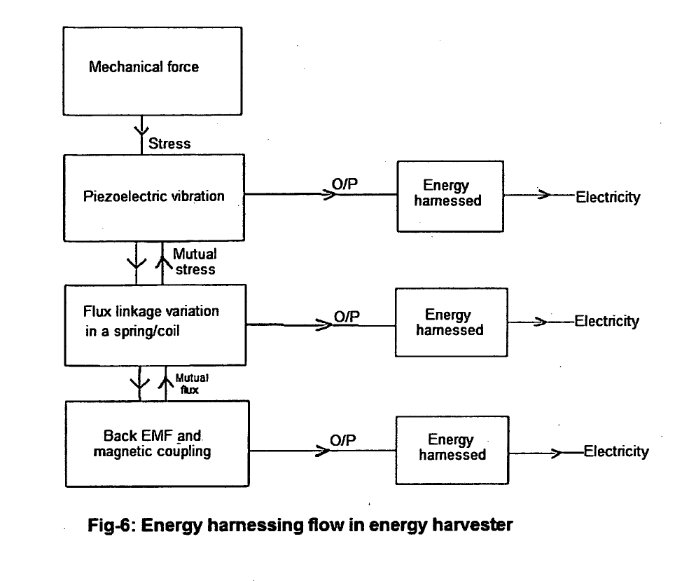

1. This method is not limited to the number of magnets or number of coils/springs used in the design of the framework

2. This method is not limited to the material or design of secondary coils used for magnetic coupling

3. This method is not limited to the material or design of primary coil

4. This method is not limited to the material, shape and size of permanent magnet

5. This method is not limited to the count, type, shape, size, material of piezoelectric slabs

6. This method is not limited to the binding material used to associate the energy harvester to the surface generating vibration

7. This method is not limited to the binding material used in framework to hold magnets or coil in place

8. This method is not limited to extent to which conditioning or temperament of piezoelectric and electromagnetic systems individually or collectively is carried out to generate electricity from vibration/stress/motion

9. Design of the piezoelectric electromagnetic framework with electrical circuit wherein electrical circuit is a combination of, but not limited to, one or more of resistors, inductors, capacitors, semiconductors, etc

10. This method is not limited to the number of energy harvester entities that is embedded to a surface to generate electricity from a given source of vibration
